(19) United States
(12) Patent Application Publication
(10) Pub. No.: US 2006/0142442 A1
(43) Pub. Date: Jun. 29, 2006

(54) Hydrolysis-resistant polyesters

(75) Inventors: Dietrich Scherzer, Neustadt (DE); Jochen Engelmann, Neustadt (DE); Motonori Yamamoto, Mannheim (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT Patents, Trademarks and Licenses, Ludwigshafen (DE)

(21) Appl. No.: 10/543,883

(22) PCT Filed: Jan. 29, 2004
(86) PCT No.: PCT/EP04/00774

§ 371 Date: Jul. 29, 2005

(30) Foreign Application Priority Data
Feb. 3, 2003 (DE) 103 04 341.1

(51) Int. Cl. C08K 5/15

(52) U.S. Cl. 524/114

(57) ABSTRACT

Use of epoxidized natural oils or fatty esters, or a mixture of these (component B) for preparing hydrolysis-resistant thermoplastic polyester molding compositions (A).

The invention relates to the use of epoxidized natural oils or fatty esters, or a mixture of these (component B) for preparing hydrolysis-resistant thermoplastic polyester molding compositions (A).

The invention further relates to the use of epoxidized natural oils or fatty esters, or a mixture of these for increasing the hydrolysis resistance of moldings composed of thermoplastic polyesters A).

The invention also relates to the moldings of any type obtainable by the inventive use.

Polyesters exhibit properties such as resistance to numerous chemicals. However, there continues to be a need for an improvement in hydrolysis resistance, because this has a substantial effect on the shrinkage (dimensional stability) and the mechanical properties of the component.

EP-A 794 974 discloses polycarbodiimides as hydrolysis stabilizers. The toxicity of compounds of this type is problematic during processing, as is the substantial increase in costs.

Epoxidized vegetable oils and fatty esters are known as color (co)stabilizers for PVC, and as plasticizers: Gächter/Müller, Kunststoffadditive 3rd Edition, pp. 317, 318 and also 399 and 400, Carl Hanser Verlag 1989.

U.S. Pat. No. 3,886,105 discloses additives of this type for polyesters, but in connection with thermal degradation and melt stability of the polymer matrix.

It is an object of the present invention, therefore, to provide molding compositions and moldings composed of polyesters which can be used at relatively high service temperatures and which are very resistant to hydrolysis.

We have found that this object is achieved by way of the uses defined at the outset. Preferred embodiments can be found in the subclaims.

As component (A), the molding compositions which can be used according to the invention comprise from 29 to 99.9% by weight, preferably from 40 to 95.5% by weight, and in particular from 40 to 80% by weight, of a thermoplastic polyester.

Use is generally made of polyesters A) based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are known per se and are described in the literature. Their main chain contains an aromatic ring which derives from the aromatic dicarboxylic acid. There may also be substitution in the aromatic ring, e.g. by halogen, such as chlorine or bromine, or by C₁-C₄-alkyl, such as methyl, ethyl, iso- or n-propyl, or n-, iso- or tert-butyl.

These polyalkylene terephthalates may be prepared by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Particularly preferred polyesters (A) are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is also given to PET and/or PBT which comprise as other monomer units, up to 1 % by weight, preferably up to 0.75% by weight, of 1,6-hexanediol and/or 2-methyl-1,5-pentanediol.

The viscosity number of the polyesters (A) is generally in the range from 50 to 220, preferably from 80 to 160 (measured in 0.5% strength by weight solution in a phenol/o-dichlorobenzene mixture (in a weight ratio of 1:1) at 25° C. in accordance with ISO 1628.

Particular preference is given to polyesters whose carboxy end group content is up to 100 mval/kg of polyester, preferably up to 50 mval/kg of polyester and in particular up to 40 mval/kg of polyester. Polyesters of this type may be prepared, for example, by the process of DE-A 44 01 055. The carboxy end group content is usually determined by titration methods (e.g. potentiometry).

Particularly preferred molding compositions comprise, as component A), a mixture of polyesters other than PBT, for example polyethylene terephthalate (PET). The proportion of the polyethylene terephthalate in the mixture is, for example, preferably up to 50% by weight, in particular from 10 to 35% by weight, based on 100% by weight of A).

It is also advantageous, where appropriate, to use recycled PET materials (also termed scrap PET) in a mixture with polyalkylene terephthalates, such as PBT.

Recycled materials are generally:
1) those known as post-industrial recycled materials: these are production wastes during polycondensation or during processing, e.g. sprues from injection molding, start-up material from injection molding or extrusion, or edge trims from extruded sheets or films.
2) Post-consumer recycled materials: these are plastic items which are collected and treated after utilization by the end consumer. Blow-molded PET bottles for mineral water, soft drinks and juices are easily the predominant items in terms of quantity.

Both types of recycled material may be used either as regrind or in the form of pellets. In the latter case, the crude recycled materials are isolated and purified and then melted and pelletized using an extruder. This usually facilitates handling and free-flowing properties, and metering for further steps in processing.

The recycled materials used may either be pelletized or in the form of regrind. The edge length should not be more than 6 mm and should preferably be less than 5 mm.

Because polyesters undergo hydrolytic cleavage during processing (due to traces of moisture) it is advisable to predry the recycled material. The residual moisture after drying is preferably <0.2%, in particular <0.05%.

Another class to be mentioned is that of fully aromatic polyesters deriving from aromatic dicarboxylic acids and aromatic dihydroxy compounds.

Suitable aromatic dicarboxylic acids are the compounds previously described for the polyalkylene terephthalates. The mixtures preferably used are made from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the formula 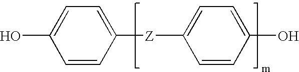
where Z is alkylene or cycloalkylene having up to 8 carbon atoms, arylene having up to 12 carbon atoms, carbonyl, sulfonyl, oxygen or sulfur or a chemical bond, and where m is from 0 to 2. The phenylene groups in the compounds may also have substitution by C₁-C₆-alkyl or alkoxy and fluorine, chlorine or bromine.

Examples of parent compounds for these compounds are
dihydroxydiphenyl,
di(hydroxyphenyl)alkane,
di(hydroxyphenyl)cycloalkane,
di(hydroxyphenyl) sulfide,
di(hydroxyphenyl) ether,
di(hydroxyphenyl) ketone,
di(hydroxyphenyl) sulfoxide,
α,α′-di(hydroxyphenyl)dialkylbenzene,
di(hydroxyphenyl) sulfone, di(hydroxybenzoyl)benzene
resorcinol, and
hydroquinone, and also the ring-alkylated and ring-halogenated derivatives of these.

Among these, preference is given to
4,4′-dihydroxydiphenyl,
2,4-di(4′-hydroxyphenyl)-2-methylbutane
α,α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,
   and in particular to
2,2-di(4′-hydroxyphenyl)propane
2,2-di(3′,5-dichlorodihydroxyphenyl)propane,
1,1 -di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane
   or a mixture of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyether-esters. Products of this type are known per se and are described in the literature, e.g. in U.S. Pat. No. 3,651,014. Corresponding products are also available commercially, e.g. Hytrel® (DuPont).

According to the invention, halogen-free polycarbonates are also polyesters. Examples of suitable halogen-free polycarbonates are those based on diphenols of the formula 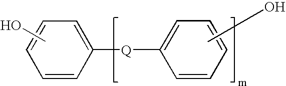
where Q is a single bond, C₁-C₈-alkylene, C₂-C₃-alkylidene, C₃-C₆-cycloalkylidene, C₆-C₁₂-arylene or else —O—, —S— or —SO₂—, and m is an integer from 0 to 2.

The phenylene radicals of the biphenols may also have substituents, such as C₁-C₆-alkyl or C₁-C₆-alkoxy.

Examples of preferred biphenols of this formula are hydroquinone, resorcinol, 4,4′-dihydroxydiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component A, and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the biphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to an average molar mass M_{w} (weight average) of from 10 000 to 200 000 g/mol, preferably from 20 000 to 80 000 g/mol.

The biphenols of this formula are known per se or can be prepared by known processes.

The polycarbonates may, for example, be prepared by reacting the biphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782).

Examples of suitable chain terminators are phenol, p-tert-butylphenol, or else long-chain alkylphenols, such as 4-(1,3-tetramethylbutyl)phenol, as in DE-A 28 42 005, or monoalkylphenols, or dialkylphenols with a total of from 8 to 20 carbon atoms in the alkyl substituents, as in DE-A 35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates made from halogen-free biphenols, from halogen-free chain terminators and, where appropriate, from halogen-free branching agents, where the content of subordinate amounts at the ppm level of hydrolyzable chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable components A) which may be mentioned are amorphous polyester carbonates, where phosgene has been replaced, during the preparation, by aromatic di-carboxylic acid units, such as isophthalic acid and/or terephthalic acid units. For further details reference may be made at this point to EP-A 711 810.

Other suitable copolycarbonates with cycloalkyl radicals as monomer units have been described in EP-A 365 916.

It is also possible to replace bisphenol A with bisphenol TMC. Polycarbonates of this type are commercially available from Bayer with the trademark APEC HT®.

As component B), the molding compositions which may be used according to the invention comprise from 0.01 to 10% by weight, preferably from 0.5 to 7% by weight, and in particular from 1 to 5% by weight, of epoxidized natural oils or fatty esters or a mixture of these.

As component B), preference is given to the use of those epoxidized compounds whose epoxy groups are non-terminal (these being known as epoxy groups “internal” to the hydrocarbon chain).

The content of epoxy groups is preferably from 1 to 20% by weight, with preference from 4 to 15% by weight, and in particular from 6 to 12% by weight, based on the respective component B).

Preferred natural oils are olive oil, linseed oil, palm oil, groundnut oil, coconut oil, tung oil, rapeseed oil, castor oil, fish-liver oil, or a mixture of these, particular preference being given to soybean oil.

The molecular weight of these oils is preferably from 500 to 1000, in particular from 600 to 900. These linseed or soybean oils are mixtures of fatty acid triglycerides where the C₁₈ carboxylic acid fraction is predominant.

The epoxidized fatty esters can generally be prepared from these natural oils by methods familiar to the person skilled in the art.

Preference is given to esters of saturated or unsaturated aliphatic carboxylic acids having from 10 to 40, preferably from 16 to 22, carbon atoms with saturated aliphatic alcohols having from 2 to 40, preferably from 2 to 6, carbon atoms.

The carboxylic acids may be mono- or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms), linoleic acid, linolenic acid, and eleostearic acid, oleic acid.

The aliphatic alcohols may be mono- to tetrahydric. Examples of alcohols are n-butanol, n-octanol, stearyl alcohol, ethylene glycol, propylene glycol, neopentyl glycol, pentaerythritol, myricyl alcohol, cetyl alcohol, and preferably glycerol.

It is also possible to use mixtures of various esters and/or oils.

Component B) preferably comprises unsaturated fatty acid fractions corresponding to an iodine number (to DIN 53995) of from 130 to 180 mg, in particular from 120 to 200 mg, of iodine per gram of substance.

The introduction of the epoxy function into the abovementioned oils and/or esters takes place via reaction of these with epoxidizing agents, e.g. peracids, such as peracetic acid. Reactions of this type are known to the person skilled in the art, and further information in this connection would therefore be superfluous.

As component C), the molding compositions which may be used according to the invention may comprise from 0 to 70% by weight, in particular up to 50% by weight, of other additives.

As component C), the molding compositions of the invention may comprise from 0 to 5% by weight, in particular from 0.01 to 5% by weight, preferably from 0.05 to 3% by weight, and in particular from 0.1 to 2% by weight, of at least one ester or amide of saturated or unsaturated aliphatic carboxylic acids having from 10 to 40, preferably from 16 to 22, carbon atoms with saturated aliphatic alcohols or amines having from 2 to 40, preferably from 2 to 6, carbon atoms. These differ from B) because no epoxy functions are present.

The carboxylic acids may be monobasic or dibasic. Examples which may be mentioned are pelargonic acid, palmitic acid, lauric acid, margaric acid, dodecanedioic acid, behenic acid, and particularly preferably stearic acid, capric acid, and montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono-, di- or triamines. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use combinations of various esters or amides, or esters with amides, in any desired mixing ratio. A particularly advantageous method is addition of this component C) in amounts of from 0.1 to 0.8% by weight, in particular from 0.5 to 0.7% by weight, based on A) on achieving at least 80% of the desired final viscosity of component A), and then compounding with the other components B) to C).

Examples of other additives C) are amounts of up to 40% by weight, preferably up to 30% by weight, of elastomeric polymers (often also termed impact modifiers, elastomers, or rubbers).

These are very generally copolymers which have preferably been built up from at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, or mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also include dicarboxylic acids, such as maleic acid and fumaric acid, or derivatives of these acids, e.g. esters and anhydrides, and/or monomers containing epoxy groups. These monomers containing dicarboxylic acid derivatives or containing epoxy groups are preferably incorporated into the rubber by addition to the monomer mixture of monomers containing dicarboxylic acid groups and/or epoxy groups and having the formula I, II, III or IV 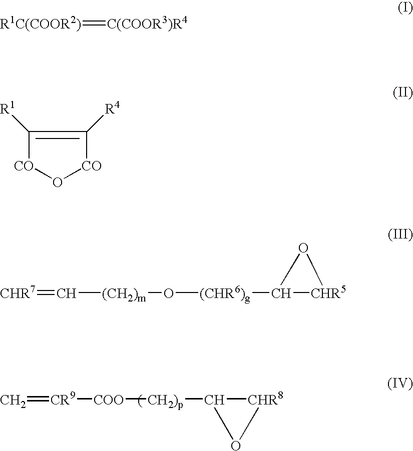
where R¹ to R⁹ are hydrogen or alkyl having from 1 to 6 carbon atoms, and m is an integer from 0 to 20, g is an integer from 0 to 10 and p is an integer from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates containing epoxy groups, such as glycidyl acrylate and glycidyl methacrylate, and the esters with tertiary alcohols, such as tert-butyl acrylate. Although the latter have no free carboxy groups their behavior approximates to that of the free acids and they are therefore termed monomers with latent carboxy groups.

The copolymers are advantageously composed of from 50 to 98% by weight of ethylene, from 0.1 to 20% by weight of monomers containing epoxy groups and/or methacrylic acid and/or monomers containing anhydride groups, the remaining amount being (meth)acrylates.

Particular preference is given to copolymers made from
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 10 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Preferred elastomers also include emulsion polymers whose preparation is described, for example, by Blackley in the monograph “Emulsion Polymerization”. The emulsifiers and catalysts which may be used are known per se.

In principle it is possible to use homogeneously structured elastomers or those with a shell construction. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, and corresponding methacrylates, and butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell made from a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, a-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the formula 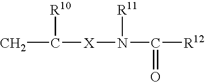
where:
R¹⁰ is hydrogen or C₁-C₄-alkyl,
R¹¹ is hydrogen, C₁-C₈-alkyl or aryl, in particular phenyl,
R¹² is hydrogen, C₁-C₁₀-alkyl, C₆-C₁₂-aryl or —OR¹³,
R¹³ is C₁-C₈-alkyl or C₆-C₁₂-aryl, where appropriate with substitution by O— or N-containing groups,
X is a chemical bond, C₁-C₁₀-alkylene or C₆-C₁₂-arylene, or 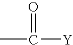
Y is O-Z or NH-Z, and
Z is C₁-C₁₀-alkylene or C₆-C₁₂-arylene.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP A 50 265.

It is also possible to use the monomers known as graft-linking monomers, i.e. monomers having two or more polymerizable double bonds which react at different rates during the polymerization. Preference is given to the use of those compounds in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers containing allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Instead of graft polymers whose structure has more than one shell it is also possible to use homogeneous, i.e. single-shell, elastomers made from 1,3-butadiene, isoprene and n-butyl acrylate or from copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core made from n-butyl acrylate or based on butadiene and with an outer envelope made from the abovementioned copolymers, and copolymers of ethylene with comonomers which supply reactive groups.

The elastomers described may also be prepared by other conventional processes, e.g. by suspension polymerization.

Silicone rubbers, as described in DE-A 37 25 576, EP-A 235 690, DE-A 38 00 603 and EP-A 319 290, are likewise preferred.

It is, of course, also possible to use mixtures of the abovementioned rubber types.

Fibrous or particulate fillers C) which may be mentioned are carbon fibers, glass fibers, glass beads, amorphous silica, asbestos, calcium silicate, calcium metasilicate, magnesium carbonate, kaolin, chalk, powdered quartz, mica, barium sulfate and feldspar, used in amounts of up to 50% by weight, in particular from 1 to 50% by weight, preferably from 5 to 40% by weight, and in particular from 15 to 35% by weight.

Preferred fibrous fillers which may be mentioned are carbon fibers, aramide fibers and potassium titanate fibers, and particular preference is given to glass fibers in the form of E glass. These may be used as rovings or in the commercially available forms of chopped glass.

The fibrous fillers may have been surface-pretreated with a silane compound to improve compatibility with the thermoplastic.

Suitable silane compounds have the formula:
(X—(CH₂)ₙ)ₖ—Si—(O—CₘH₂ₘ₊₁)₄₋ₖ
where:
X is NH₂—, 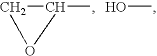
n is an integer from 2 to 10, preferably 3 or 4,
m is an integer from 1 to 5, preferably 1 or 2, and
k is an integer from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which contain a glycidyl group as substituent X.

The silane compounds are generally used for surface coating in amounts of from 0.05 to 5% by weight, preferably from 0.5 to 1.5% by weight and in particular from 0.8 to 1% by weight (based on C).

Acicular mineral fillers are also suitable.

For the purposes of the present invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, where appropriate, have been pretreated with the abovementioned silane compounds, but the pretreatment is not essential.

Other fillers which may be mentioned are kaolin, calcined kaolin, wollastonite, talc, and chalk.

As component C), the thermoplastic molding compositions of the invention may comprise conventional processing aids, such as stabilizers, oxidation retarders, agents to counteract decomposition by heat and decomposition by ultraviolet light, other lubricants and release agents, colorants, such as dyes and pigments, nucleating agents, plasticizers, flame retardants, etc.

UV stabilizers are generally used in amounts of up to 2% by weight, based on the molding composition, and those which may be mentioned are various substituted resorcinols, salicylates, benzotriazoles, and benzophenones.

Preferred suitable stabilizers are organic phosphonites C) of the formula I 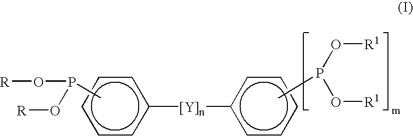
where
m is 0 or 1,
n is 0 or 1,
y is an oxygen bridge, a sulfur bridge, or a 1,4-phenylene bridge, or a bridging unit of formula —CH(R²)—; all of the R—O— and R¹—O-groups are independent of one another and are the radical of an aliphatic, alicyclic or aromatic alcohol which may contain up to three hydroxy groups, excluding any arrangement of the hydroxy groups which permits these to be parts of a phosphorus-containing ring (termed monovalent R—O-groups), or two R—O— or, respectively, R¹—O-groups, bonded to a phosphorus atom, in each case independently of one another, together are the radical of an aliphatic, alicyclic or aromatic alcohol having a total of up to three hydroxy groups (termed di-valent R—O— or, respectively, R¹—O-groups),
R² is hydrogen, C₁-C₈-alkyl or a group of the formula COOR³, and
R³ is C₁₋₈-alkyl.

It is preferable for at least one R—O and at least one R¹—O-group to be a phenol radical which carries a sterically hindered group, in particular tert-butyl, in the 2-position.

Particular preference is given to tetrakis-(2,4-di-tert-butylphenyl) biphenylenediphosphonite, which is available commercially from Ciba Geigy AG as Irgaphos® PEPQ.

If R—O— and R¹—O— are divalent radicals, they preferably derive from di- or trihydric alcohols.

R preferably has the same meaning as R¹, and this is alkyl, aralkyl (preferably substituted or unsubstituted phenyl or phenylene), aryl (preferably substituted or unsubstituted phenyl) or a group of the formula a 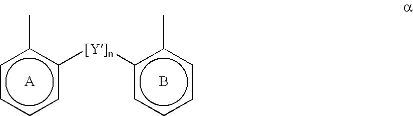
where the rings A and B may carry other substituents and
Y′ is an oxygen bridge or a sulfur bridge or a bridging unit of the formula —CH(R³)—,
R² is hydrogen, C₁-C₈-alkyl or a group of the formula —COOR ³, and
R³ is C₁-C₈-alkyl, and
n is 0 or 1 (termed divalent R′).

Particularly preferred radicals R are the radicals R″, where this is C₁-C₂₂-alkyl, phenyl, which may carry from 1 to 3 substituents selected from the class consisting of cyano-C₁-C₂₂-alkyl, C₁-C₂₂-alkoxy, benzyl, phenyl, 2,2,6,6-tetramethylpiperidyl-4-, hydroxy, C₁-C₈-alkylphenyl, carboxy, —C(CH₃)₂—C₆H₅), —COO—C₁-C₂₂-alkyl, CH₁₂—CH₂—COOH, —CH₂CH₂COO—, C₁-C₂₂-alkyl or —CH₂—S—C₁-C₂₂-alkyl; or a group of the formulae i to vii. 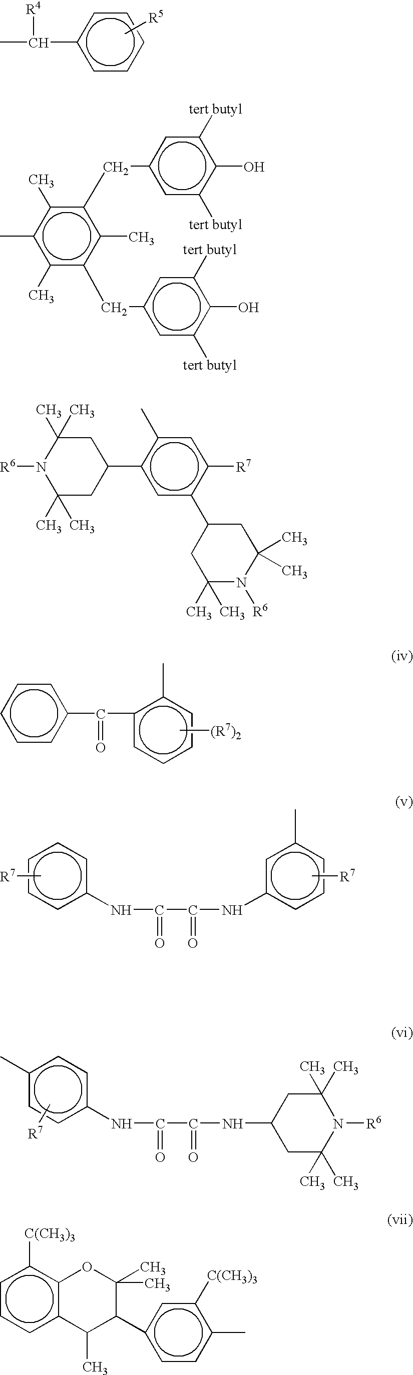
or two groups R″ together are a group of the formula viii 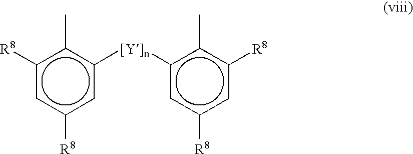
where
R⁸ is hydrogen or C₁-C₂₂-alkyl,
R⁶ is hydrogen, C₁-C₄-alkyl or —CO—C₁-C₈-alkyl,
R⁴ is hydrogen or C₁-C₂₂-alkyl,
R⁵ is hydrogen, C₁-C₂₂-alkyl, C₁-C₂₂-alkoxy, benzyl, cyano, phenyl, hydroxy, C₁-C₈-alkylphenyl, C₁-C₂₂-alkoxycarbonyl, C₁-C₂₂-alkoxycarbonylethyl, carboxyethyl, 2,2,6,6-tetramethylpiperidyl-4-, or a group of the formula —CH₂—S—C₁-C₂₂₋alkyl or —C(CH₃)₂—C₆H₅ and
R⁷ is hydrogen, C₁-C₂₂-alkyl, hydroxy or alkoxy, and
Y′ and n are as defined above.

Particularly preferred radicals R are those radicals R″ which have one of the formulae a to g 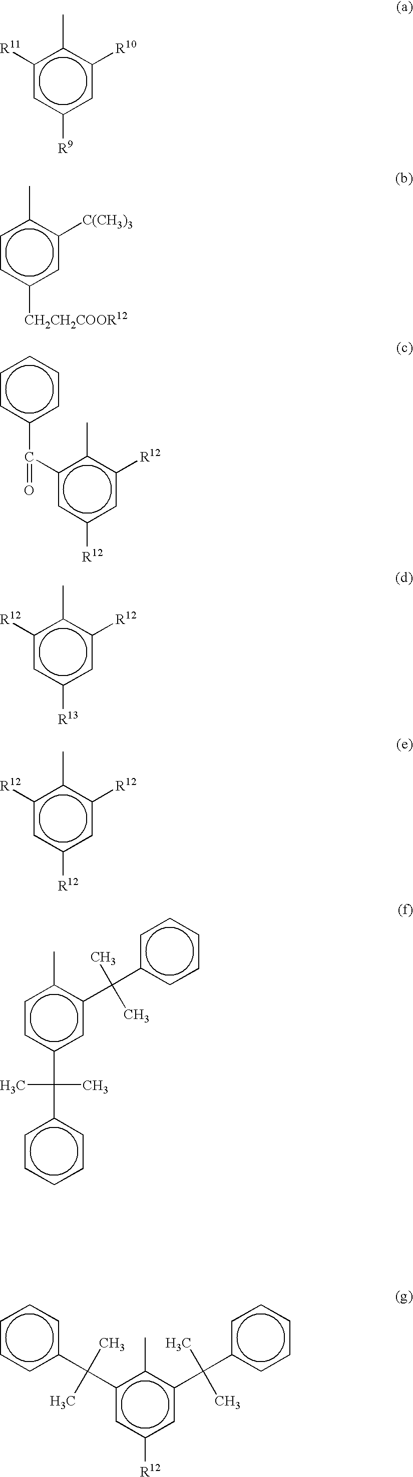
where
R⁹ is hydrogen, C₁-C₈-alkyl, C₁-C₈-alkoxy, phenyl, C₁-C₈-alkylphenyl or phenyl-C₁-C₈-alkylphenyl or phenyl-C₁-C₄-alkyl,
R¹⁰ and R¹¹, independently of one another, are hydrogen, C₁-C₂₂-alkyl, phenyl or C₁-C₈-alkylphenyl,
R¹² is hydrogen or C₁-C₈-alkyl, and
R¹³ is cyano, carboxy or C₁-C₈-alkoxycarbonyl.

Among groups of the formula a, preference is given to 2-tert-butylphenyl, 2-phenylphenyl, 2-(1′,1′-dimethylpropyl)phenyl, 2-cyclohexylphenyl, 2-tert-butyl-4-methylphenyl, 2,4-di-tert-amylphenyl, 2,4-di-tert-butylphenyl, 2,4-diphenylphenyl, 2,4-di-tert-octylphenyl, 2-tert-butyl-4-phenylphenyl, 2,4-bis(1′,1′-dimethylpropyl)phenyl, 2-(1′-phenyl-1′-methylethyl)phenyl, 2,4-bis(1′-phenyl-1′-methylethyl)phenyl and 2,4-di-tert-butyl-6-methylphenyl.

Processes for preparing the phosphonites C) may be found in DE-A 40 01 397 and these may be present in the molding compositions in amounts of from 0.001 to 5% by weight, preferably from 0.01 to 3% by weight. Other phosphorus-containing stabilizers which may be mentioned, in the above-mentioned amounts, are inorganic compounds of phosphoric acid, preference being given to alkaline earth metals and alkali metals. Particular preference is given to zinc phosphate or zinc dihydrogenphosphate.

Examples of colorants which may be added are inorganic pigments, such as ultramarine blue, iron oxide, zinc sulfide, titanium dioxide, or carbon black, and also organic pigments, such as phthalocyanines, quinacridones, perylenes, and also dyes, such as anthraquinones.

Nucleating agents which may be used are sodium phenylphosphinate, aluminum oxide, silicon dioxide and preferably talc.

Other lubricants and mold-release agents, which are usually used in amounts of up to 1% by weight, are preferably long-chain fatty acids (e.g. stearic acid or behenic acid), salts of these (e.g. Ca stearate or Zn stearate) or montan waxes (mixtures of straight-chain saturated carboxylic acids with chain lengths of from 28 to 32 carbon atoms), or salts of these with alkali metals or with alkaline earth metals, preferably Ca montanate and/or sodium montanate, and also low-molecular-weight polyethylene waxes or low-molecular-weight polypropylene waxes.

Examples of plasticizers which should be mentioned are dioctyl phthalate, dibenzyl phthalate, butyl benzyl phthalate, hydrocarbon oils and N-(n-butyl)benzenesulfonamide.

The thermoplastic molding compositions of the invention may be prepared by processes known per se, by mixing the starting components in conventional mixing apparatus, such as screw extruders, Brabender mixers, or Banbury mixers, and then extruding them. The extrudate may be cooled and comminuted. It is also possible to premix individual components and then to add the remaining starting materials individually and/or likewise mixed. The mixing temperatures are generally from 230 to 290° C.

In one preferred procedure, components B) to C) may be mixed with a polyester pre-polymer, compounded, and pelletized. The resultant pellets are then condensed in the solid phase under an inert gas, continuously or batchwise, at a temperature below the melting point of component A), until the desired viscosity has been reached.

The molding compositions which may be used according to the invention feature substantially improved hydrolysis resistance.

They are suitable for producing fibers, films, or moldings of any type, these having increased hydrolysis resistance. Particular applications among these are toothbrush bristles, paper sieving fabric, superheated-steam-sterilizable films and moldings, pipes, moldings and profiles for the motor vehicle sector, where these have exposure to elevated temperature and moisture level, and also polyester molding compositions for coating of paper and paperboard, for producing films, profiles, or pipes, and polyester molding compositions for producing functional technical components by injection molding, for example motor vehicle components, parts for the electrical industry, and parts with high resistance to heat and hydrolysis, and also exterior motor vehicle parts, such as bumpers and spoilers, gasoline- and oil-resistant technical components with good paintability, housings and switch covers, plug connectors, switches, motor housings, headlamp parts, and also electrical components, such as microswitches, capacitor cups, switch parts, circuit-breaker housings, printed circuit boards.

### EXAMPLES

Component A₁: polybutylene terephthalate (PBT) with a viscosity number of 130 ml/g and having a carboxy end group content of 25 mval/kg (VN measured in 0.5% by weight strength solution of phenol/o-dichlorobenzene, 1:1 mixture, at 35° C. to ISO 1628), comprising 0.65% by weight, based on A₁, of pentaerythritol tetrastearate (component C1)
Component A₂: PBT with a VN of 107 ml/g (without component C1)
Component B₁: epoxidized soybean oil (epoxy content: about 8% by weight) (Edenol® D81 from the company Cognis GmbH)
Component B₂: epoxidized soybean oil (epoxy content: about 8% by weight) (Merginat® ESB from the company Harburger Fettchemie Brinkmann & Mergell GmbH)
Component B₃: epoxidized linseed oil (epoxy content: about 9% by weight) (Merginat® ELO from the company Harburger Fettchemie Brinkmann & Mergell GmbH)
Component B₄: for comparison as in EP 794 974, carbodiimide based on 1,3-bis(1-isocyanato-1-methylethyl)benzene in polyethylene terephthalate (Stabaxol® MBPET 5010 from the company Rheinchemie GmbH)
Ratio by weight: PCDI:PET 15%:85%
Component C₂: chopped glass fibers with an average length of 4 mm (epoxysilanized size)
Component C₃: talc
   Preparation of Molding Compositions

Components A) to C) were mixed in the quantitative proportions given in the table in an extruder at 260° C., homogenized, pelletized, and dried. Charpy test specimen: 80×10×4 mm³, tensile test: DIN dumbbell specimen

Modulus of elasticity and elongation at break were determined to ISO 527-2, and Charpy was determined to ISO 179/1 eU.

The melt index was determined by measuring MVR at 275° C. and, respectively, 250° C., with 2.16 kg load.

The constitutions of the molding compositions and the results of the tests are given in the table.

| Components | | | Inventive | Inventive | Inventive | Inventive | Inventive | Inventive | Inventive |
|---|---|---|---|---|---|---|---|---|---|
| [% by wt] | Comparison 1 | Comparison 2 | example 3 | example 4 | example 5 | example 6 | example 7 | example 8 | example 9 |
| A₁ | 69.9 | 59.9 | 68.9 | 67.9 | 64.9 | 67.9 | 68.9 | — | — |
| A₂ | — | — | — | — | — | — | — | 70 | 68 |
| B₁ | — | — | 1 | 2 | 5 | — | — | — | 2 |
| B₂ | — | — | — | — | — | 2 | — | — | — |
| B₃ | — | — | — | — | — | — | 1 | — | — |
| B₄ | — | 10 | — | — | — | — | — | — | — |
| C₂ | 30 | 30 | 30 | 30 | 30 | 30 | 30 | 30 | 30 |
| C₃ | 0.1 | 0.1 | 0.1 | 0.1 | 0.1 | 0.1 | 0.1 | — | — |
| Unaged values | | | | | | | | | |
| VN | 112 | 153 | 118 | 111 | 111 | 116 | 110 | 116 | 114 |
| MVR | 19.6 | 6.8 | 14.9 | 14.7 | 21.5 | 14.3 | 13.4 | 17.9 | 15.3 |
| (275, 2.16 kg) | | | | | | | | | |
| Tensile stress at | 140 | 130 | 133 | 130 | 111 | 133 | 131 | 143 | 136 |
| break (N/mm²) | | | | | | | | | |
| Tensile strain at | 3 | 3 | 3 | 3 | 4 | 3 | 3 | 3 | 3 |
| break (%) | | | | | | | | | |
| Modulus of | 9822 | 9775 | 9401 | 9296 | 8084 | 9389 | 9131 | 9682 | 9334 |
| elasticity (N/mm²) | | | | | | | | | |
| Charpy impact | 72 | 71 | 71 | 73 | 64 | 71 | 73 | 75 | 74 |
| strength | | | | | | | | | |
| at 23° C. (kJ/m²) | | | | | | | | | |
| Values with 4 | | | | | | | | | |
| days of ageing | | | | | | | | | |
| at 110° C., 100% | | | | | | | | | |
| humidity | | | | | | | | | |
| Tensile stress at | 97 | 78 | 116 | 114 | 102 | 117 | 115 | 96 | 116 |
| break (N/mm²) | | | | | | | | | |
| Tensile strain at | 2 | 1 | 2 | 2 | 3 | 3 | 3 | 2 | 2 |
| break (%) | | | | | | | | | |
| Modulus of | 9208 | 9166 | 8640 | 8634 | 7611 | 8694 | 8440 | 9175 | 8711 |
| elasticity (N/mm²) | | | | | | | | | |
| Charpy impact | 17 | 16 | 38 | 39 | 40 | 35 | 39 | 18 | 41 |
| strength at 23° C. | | | | | | | | | |
| (kJ/m²) | | | | | | | | | |
| Values with 8 | | | | | | | | | |
| days of ageing | | | | | | | | | |
| at 110° C., 100% | | | | | | | | | |
| humidity | | | | | | | | | |
| Tensile stress at | 34 | 66 | 73 | 83 | 98 | 84 | 87 | 33 | 81 |
| break (N/mm²) | | | | | | | | | |
| Tensile strain at | 1 | 2 | 1 | 1 | 2 | 1 | 1 | 2 | 1 |
| break (%) | | | | | | | | | |
| Modulus of | 7524 | 8918 | 8669 | 8691 | 7627 | 8712 | 8465 | 6970 | 8594 |
| elasticity (N/mm²) | | | | | | | | | |
| Charpy impact | 4 | 17 | 15 | 17.3 | 32.9 | 14 | 16 | 5 | 18.4 |
| strength at 23° C. | | | | | | | | | |
| (kJ/m²) | | | | | | | | | |

1. A method comprising using epoxidized natural oils or fatty esters, or a mixture of these (component B) for preparing hydrolysis-resistant thermoplastic polyester molding compositions (A).

2. A method comprising using epoxidized natural oils or fatty esters, or a mixture of these, for increasing the hydrolysis resistance of moldings composed of thermoplastic polyesters A).

3. The method of claim 1, where the epoxy group content of B) is from 1 to 20% by weight.

4. The method of claim 1, where the epoxy groups of component B) are non-terminal.

5. The method of claim 1, where the polyester molding compositions may also comprise up to 70% by weight, based on the molding compositions composed of A) to C), of other additives (C).

6. The method of claim 1, where the amount of component B) is from 0.01 to 10% by weight, based on A) to C).

7. The method of claim 1, where component A) is composed of epoxidized olive oil, linseed oil, soybean oil, palm oil, ground nut oil, coconut oil, tung oil, fish-liver oil, or a mixture of these.

8. The method of claim 1, where the epoxidized fatty esters B) are composed of saturated or unsaturated aliphatic carboxylic acids having from 10 to 40 carbon atoms with saturated aliphatic alcohols having from 2 to 40 carbon atoms.

9. A hydrolysis-resistant molding, fiber, or film obtainable by the method of claim 1.

10. An injection molding, a coated molding, a molding for electrical or electronic uses, a motor vehicle component, obtainable by the method of claim 1.

11. The method of claim 2, where the epoxy group content of B) is from 1 to 20% by weight.

12. The method of claim 2, where the epoxy groups of component B) are non-terminal.

13. The method of claim 3, where the epoxy groups of component B) are non-terminal.

14. The method of claim 2, where the polyester molding compositions may also comprise up to 70% by weight, based on the molding compositions composed of A) to C), of other additives (C).

15. The method of claim 3, where the polyester molding compositions may also comprise up to 70% by weight, based on the molding compositions composed of A) to C), of other additives (C).

16. The method of claim 4, where the polyester molding compositions may also comprise up to 70% by weight, based on the molding compositions composed of A) to C), of other additives (C).

17. The method of claim 2, where the amount of component B) is from 0.01 to 10% by weight, based on A) to C).

18. The method of claim 3, where the amount of component B) is from 0.01 to 10% by weight, based on A) to C).

19. The method of claim 4, where the amount of component B) is from 0.01 to 10% by weight, based on A) to C).

20. The method of claim 5, where the amount of component B) is from 0.01 to 10% by weight, based on A) to C).
